(19) United States
(12) Patent Application Publication
(10) Pub. No.: US 2003/0188420 A1
(43) Pub. Date: Oct. 9, 2003

(54) Fly-height positioning apparatus

(75) Inventors: Sow Long Wong, Singapore (SG); Yi Qiang Yang, Singapore (SG)

Correspondence Address: PALMER & DODGE, LLP, KATHLEEN M. WILLIAMS, 111 HUNTINGTON AVENUE, BOSTON, MA, 02199, US

(73) Assignee: ATS Automation Asia Pte Ltd

(21) Appl. No.: 10/118,397

(22) Filed: Apr. 8, 2002

(51) Int. Cl. G11B 5/127; H04R 31/00; B23P 19/00

(52) U.S. Cl. 29/603.04; 29/603.09; 29/737; 29/729

(57) ABSTRACT

A head slider of a suspension supports a read/write head for data transfer to and from a data storage disk. A mounting structure is conventionally used for holding the suspension. A positioning finger applies a force to the suspension for and thereby positions a head slider to a static height for simulating the “flying” action of the head slider in the data storage device. A measuring device measures the static height of the head slider and transmits the same to a controller which generates a control strategy for positioning the head slider of the suspension to the fly-height. An embodiment of the invention uses a common mounting assembly for receiving a plurality of suspensions. The use of a common positioning assembly for simultaneously positioning the head sliders of the plurality of suspensions substantially reduces time consumed and improves efficiency.

### FIELD OF INVENTION

The present invention relates generally to a fly-height positioning apparatus. In particular, the invention relates to a fly-height positioning apparatus for positioning a head slider of a suspension at a desired fly-height.

### BACKGROUND

Suspensions are well known and commonly used within dynamic magnetic and optical information storage devices or drives. A suspension is a component which positions a magnetic read/write head over a desired position on a storage medium, for example, a rigid disk. At a free end of the suspension is a head slider for supporting the read/write head. The suspension is normally combined with an actuator arm to which a mounting region of the suspension is mounted so as to position the suspension and thus the head slider and the read/write head.

The aerodynamically designed head slider enables the head slider to “fly” on an air bearing (or air layer) generated by a spinning storage disk. The “flying” action positions the head slider at a desired fly-height. The suspension is resilient to allow movements along pitch and roll axes to accommodate surface variations in the spinning storage disk. The roll axis is the longitudinal axis of the suspension and the pitch axis is perpendicular to the roll axis and the surface of the suspension.

Densely packed data on the spinning storage disk requires precision in positioning the read/write head on the storage disk. Therefore, the position or attitude of the head slider as it “flies” over the storage disk is an important performance factor.

When the suspension is not actually flying over a spinning storage disk, for example during suspension testing or attitude adjustment, the flying of the suspension is simulated by applying a force to the suspension to position the head slider of the suspension at a desired fly-height. The attitude of the head slider under this simulated state is termed the static attitude. The static attitude can be measured with reference to the pitch and roll axes of the suspension. A pitch static attitude and a roll static attitude are obtained when measured with reference to the pitch and roll axes respectively. Deviations from the pitch and roll static attitudes can be quantified as pitch and roll errors. A static attitude adjustment apparatus is used to interact with the suspension to rectify pitch and roll errors.

The suspension is conventionally held within a mounting device of the static attitude adjustment apparatus by a finger applying a force to the suspension. The applied force bends the suspension to position the head slider at a static height. A measuring device measures the static height of the head slider and transmits the static height to a controller, which generates a control strategy for positioning the head slider of the suspension at the desired fly-height.

The fly-height positioning process is time-consuming and inefficient. When a production line involves a plurality of suspensions, the total time taken to position the multiple suspensions is substantial. The need to remove and replace the suspensions from the mounting structure after the static attitude of each suspension has been adjusted further adds to the time taken.

There is hence a need for a fly-height positioning apparatus for efficiently positioning a suspension or a plurality of suspensions to a desired fly-height.

### SUMMARY OF INVENTION

Therefore, in accordance with a first aspect of the invention, there is disclosed a fly-height positioning apparatus comprising:

a base structure;

a mounting structure being movably coupled to the base structure for displacing along an indexing axis, the mounting structure for receiving a plurality of suspensions, each suspension being elongated and planar; and

an indexing actuator cooperating with the base structure and the mounting structure for positioning the mounting structure along the indexing axis relative to the base structure and thereby positioning one of the plurality of suspensions at a processing position.

In accordance with a second aspect of the invention, there is disclosed a fly-height positioning method comprising the steps of:

receiving a plurality of suspensions in a mounting structure, the mounting structure being movably coupled to a base structure for displacing along an indexing axis, each suspension being elongated and planar and having a mounting aperture, and the mounting structure interacting with each mounting aperture of the plurality of suspensions for gripping the suspension;

providing an indexing actuator for cooperating with the base structure and the mounting structure to position the mounting structure along the indexing axis relative to the base structure; and

positioning one of the plurality of suspensions at a processing position along the indexing axis by the indexing actuator communicating the base structure and the mounting structure, the suspension having a mounting region and a head slider constituting two distal ends thereof.

### BRIEF DESCRIPTION OF THE DRAWINGS

Embodiments of the invention are described hereafter with reference to the following drawings, in which:

FIG. 1 is a side view of a fly-height positioning apparatus according to an embodiment of the invention;

FIG. 2 is a plan view of the fly-height positioning apparatus of FIG. 1;

FIG. 3 is a partial side view of a mounting structure of the fly-height positioning apparatus of FIG. 1 with a first jaw and a second jaw in an open position;

FIG. 4 is a partial reverse view of the fly-height positioning apparatus of FIG. 1 with a static attitude adjustment apparatus;

FIG. 5 is a perspective view of the fly-height positioning apparatus of FIG. 1 with the static attitude adjustment apparatus of FIG. 4; and

FIG. 6 is a partial perspective view of section “A” of FIG. 5 of the fly-height positioning apparatus of FIG. 1 with the static attitude adjustment apparatus of FIG. 4.

### DETAILED DESCRIPTION

A fly-height positioning apparatus for addressing the disadvantages of conventional fly-height positioning apparatuses is described in this section.

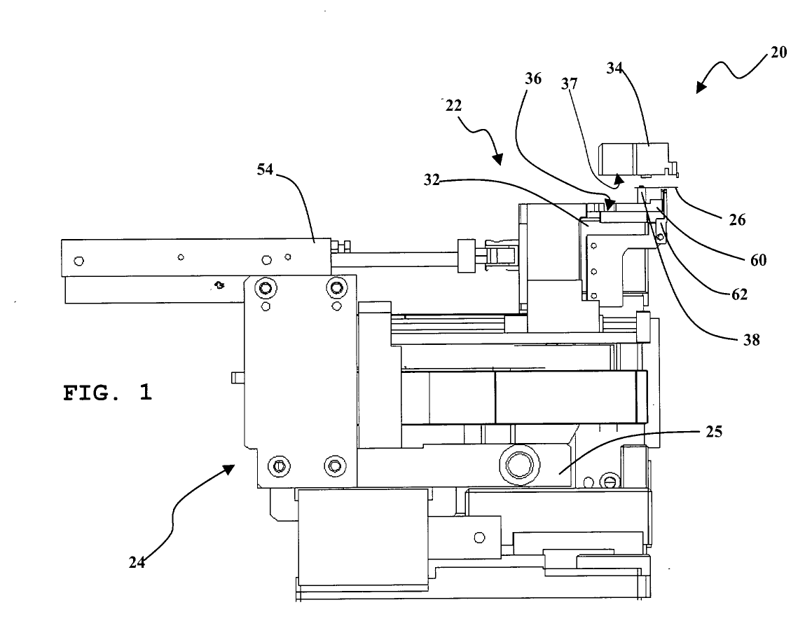

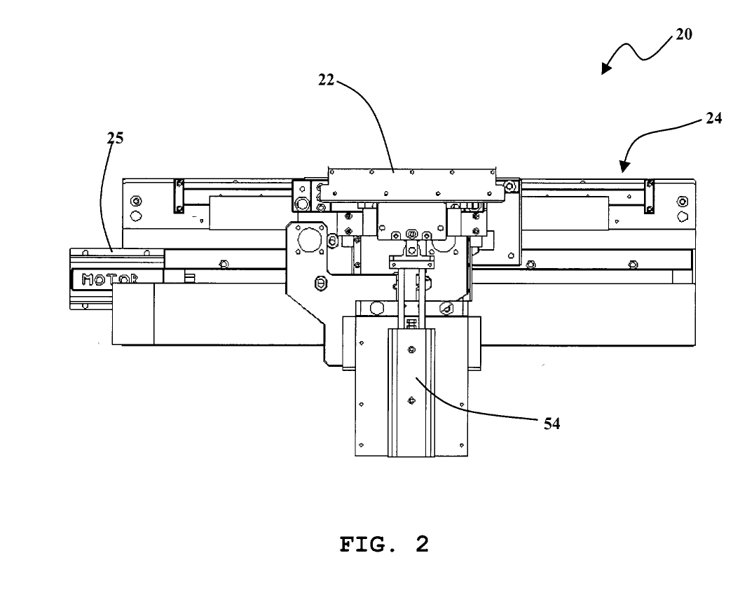

An embodiment of the invention, a fly-height positioning apparatus 20 is described with reference to FIG. 1, which shows a side view of the fly-height positioning apparatus 20, and FIG. 2, which shows a plan view of the fly-height positioning apparatus 20.

The fly-height positioning apparatus 20 includes a mounting structure 22 being movably coupled to a base structure 24 for displacing along an indexing axis (not shown). An indexing actuator 25 is mounted onto the base structure 24 and is for communicating with the base structure 24 to position the mounting structure 22 along the indexing axis. The indexing actuator 25 is preferably one of an electrical motor or a servomotor being coupled to the mounting structure 22 in a rack and pinion arrangement.

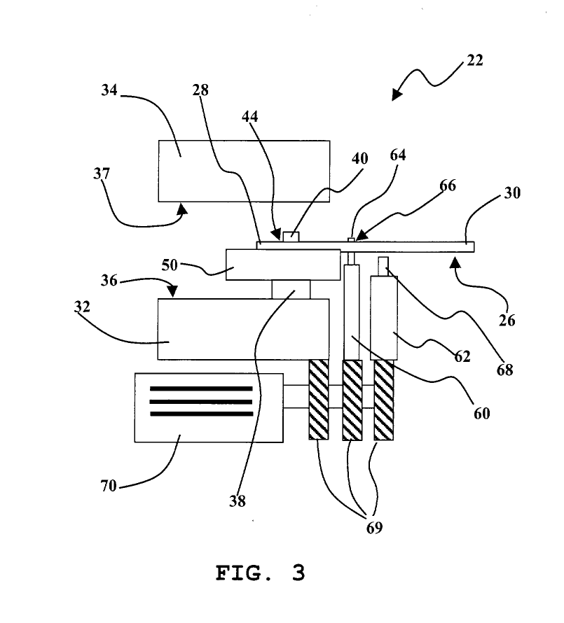

With reference to FIG. 3, which shows a partial side view of the mounting structure 22, the mounting structure 22 is for receiving one of a plurality of suspensions 26. Each suspension 26 is typically elongated and planar and has a mounting region 28 and a head slider 30 constituting the two ends of the suspension 26. The head slider 30 of the suspension 26 is for supporting a read/write head when used in a data storage medium, for example, a fixed disk drive (all not shown). The read/write head is positioned over a storage disk for data transfer to and from the storage disk.

In the fixed disk drive example, the aerodynamically designed head slider 30 enables the head slider 30 to “fly” on an air bearing generated by a spinning storage disk. The “flying” action positions the head slider 30 at a fly-height. The suspension is resilient to allow movements along pitch and roll axes to accommodate surface variations in the spinning storage disk. The roll axis is a longitudinal axis of the suspension 26 and the pitch axis is perpendicular to the roll axis and the surface of the suspension 26.

The mounting structure 22 includes a first jaw 32 and a second jaw 34 arranged for displacing in opposing directions along a vertical axis (not shown) between an open and a close position (not shown). FIG. 3 shows the first jaw 32 and the second jaw 34 in an open position. Each of the first jaw 32 and the second jaw 34 has a clamping face 36/37. The clamping face 36 of the first jaw 32 and the clamping face 37 of the second jaw 32 are inward-facing. The vertical axis is perpendicular to the indexing axis and the planar surface of the mounting region 28 of the suspension 26.

With reference to FIG. 1, FIG. 2 and FIG. 3, a plurality of datum pins 38 are positioned on the clamping face 36 of the first jaw 32 and extend perpendicularly from the clamping face 36 of the first jaw 32. A protrusion 40 is formed at a free end of each datum pin 38. Each protrusion 40 is inserted into and inlaid within a corresponding cavity (not shown) formed on the clamping face 37 of the second jaw 34 when the first jaw 32 and the second jaw 34 are engaged in the close position. Each suspension 26 has a mounting aperture (not shown) formed at the mounting region 28 which is shaped and sized to allow the protrusions 40 of the datum pins 38 to pass through. Both the protrusions 40 and the datum pins 38 are preferably cylindrical, with the datum pins 38 diametrically greater than the protrusions 40. When the suspension 26 is mounted onto the protrusions 40 of the datum pins 38, the first jaw 32 and the second jaw 34 are positioned in the close position for the datum pins 38 and the clamping face 37 of the second jaw 34 to correspondingly abut two outwardly facing surfaces (not shown) of the suspension 26 and thereby grip the suspension 26.

Each datum pin 38 is movably mounted to the first jaw 32 and is supported by a spring (not shown) within the first jaw 32. The spring resiliently biases the free ends of the datum pins 38 away from the clamping face 36 of the first jaw 32, allowing the mounting structure 22 to accommodate suspensions 26 of various thickness.

The mounting structure 22 includes a cartridge 50 with a plurality of recesses (not shown) spaced apart on a surface of the cartridge 50. The recesses (not shown) are shaped and sized to receive the mounting region 28 of the suspension 26. Each recess (not shown) has a conduit (not shown) with a central axis in the cartridge 50. The conduits coincide with the center of the mounting aperture of the suspension 26 to allow the corresponding datum pins 38 to pass through. The cartridge 50 allows a plurality of suspensions 26 to be arranged in a row before the cartridge 50 is mounted onto the mounting structure 22, so that the suspensions 26 can be readily gripped by the corresponding datum pins 38. The cartridge 50 can be easily mounted and dismounted from the mounting structure 22 by using locating elements. The first jaw 32 further displaces away from the second jaw 34 along a forward axis (not shown) to allow easy access when a user mounts or dismounts the cartridge 22. A retraction actuator 54 interacts with the first jaw 32 for displacing the first jaw 32 along the forward axis. The retraction actuator 54 is preferably a cylinder-type pneumatic actuator.

The fly-height positioning apparatus 20 also includes an alignment assembly 60 and a lifting assembly 62. The alignment assembly 60 comprises a plurality of pins 64 spaced along and extending from the alignment assembly 60. Each pin 64 corresponds to one of the suspensions 26 and is for insertion into an alignment aperture 66 on the suspension 26. The alignment aperture 66 is located on the suspension 26 between the mounting aperture and the head slider 30. When inserted into the alignment aperture 66, the pin 64 immobilizes the suspension and thereby substantially prevents movement of the suspension 26 about the central axis of the mounting aperture.

The lifting assembly 62 comprises a plurality of stubs 68 spaced apart, with each stub 68 corresponding to one of the suspensions 26. The lifting assembly 62 displaces along the vertical axis for abutting a free end of the stub 68 onto a flexure portion (not shown) of the suspension 26 thereby bending the suspension 26. The flexure portion of the suspension 26 is proximate to the head slider 30. The lifting assembly 62 is for lifting the head slider 30 of each of the suspensions 26 to a static height (not shown) relative to the mounting region 28 of the suspension 26.

The first jaw 32, the second jaw 34, the alignment assembly 60, and the lifting assembly 62 displaces relative to each other along the vertical axis. A plurality of cams 69, each with a different cam profile, interact with, and position the first jaw 32 and the second jaw 34 in the open or close positions, the alignment assembly 60 along the vertical axis and the lifting assembly 62 along the vertical axis. A cam 69 is mounted onto a positioning actuator 70 for controlling the rotational displacement of the cam 69. The positioning actuator 70 is preferably a servomotor.

The indexing actuator 25, the retraction actuator 54 and the positioning actuator 70 are electrically connected to a controller (not shown). The controller controls the indexing actuator 25 to position the mounting structure 22 along the indexing axis, which in turn positions the suspension 26 at a processing position (not shown). The fly-height positioning apparatus 20 further includes a measuring device (not shown) for measuring the static height of the head slider 30 of the suspension 26 positioned at the processing position.

When the suspension 26 is not actually flying over a spinning disk as described in the aforementioned fixed disk drive example, the fly-height of the head slider 30 is simulated by applying a force to the suspension 26. The simulation is achieved by the lifting assembly 62 interacting with the suspension 26 to position the suspension 26 at the fly-height. The attitude of the head slider in this simulated state at the fly-height is termed the static attitude. The static attitude can be measured with reference to pitch and roll axes of the suspension 26. A pitch static attitude and a roll static attitude is obtained when measured with reference to the pitch and roll axes respectively.

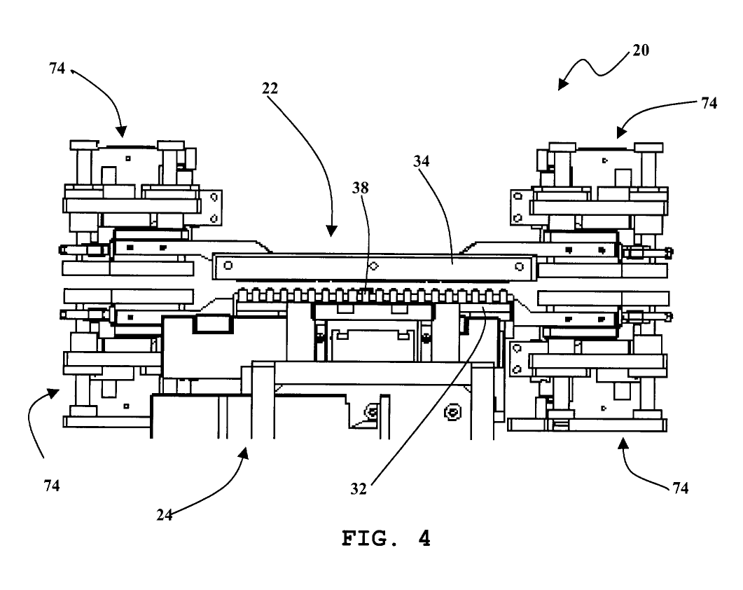

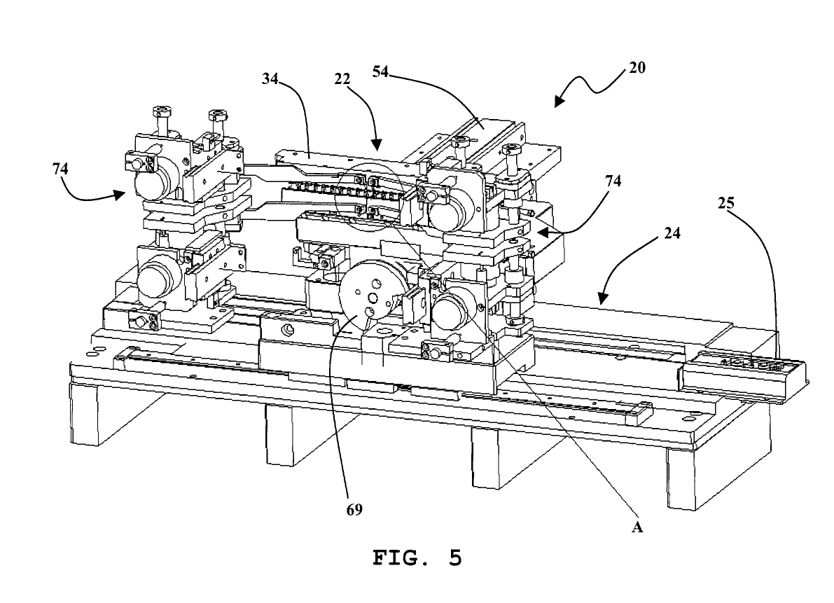

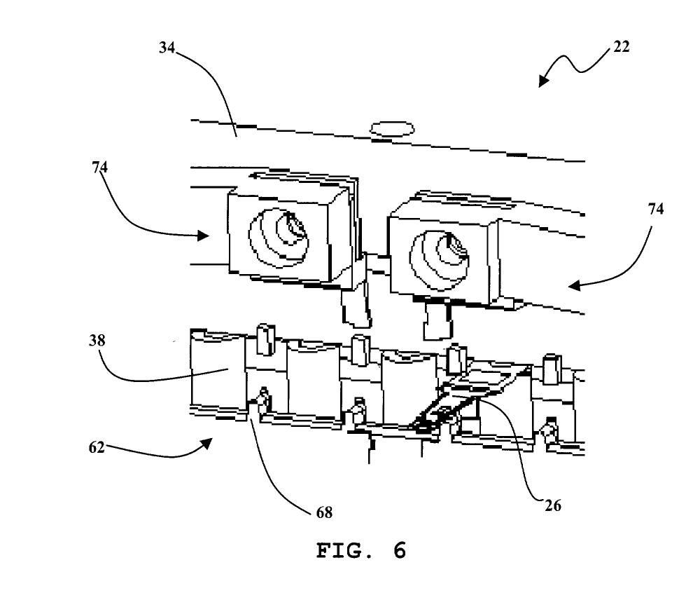

Deviations from the pitch and roll static attitudes are caused by manufacturing variations in the suspension 26, handling of the suspension 26 and other factors arising during or after manufacturing. With reference to FIG. 4, FIG. 5 and FIG. 6, a static attitude adjustment apparatus 74 is positioned and aligned for adjusting the static attitude of the suspension 26 positioned at the processing position. FIG. 4 and FIG. 5 show a partial reverse view and a perspective view respectively of the fly-height positioning apparatus 20 with the static attitude adjustment apparatus 74, and FIG. 6 shows a partial perspective view of section “A” of FIG. 5 of the fly-height positioning apparatus 20. Both the measuring device (not shown) and the static attitude adjustment apparatus 74 are electrically connected to the controller.

The controller ascertains if there is any height difference between the measured static height received from the measuring device (not shown) and a fly-height predetermined by a user. The controller then generates a control strategy based on the height difference to control the positioning actuator 70 and the rotational displacement of the cam 69, thereby positioning the head slider 30 at the fly-height.

The iterative nature of using an algorithm, such as a binary search algorithm, to generate the control strategy is time-consuming. Obtaining the static height using the measuring device (not shown) as a parameter for the control strategy, and the execution, of the control strategy by the lifting assembly 62 further adds to the time taken to position the head slider 30 at the fly-height.

This greatly reduces efficiency when positioning the fly-height for a plurality of suspensions 26 along, for example, a production line. The fly-height positioning apparatus 20 however concurrently positions the head sliders 30 of a plurality of suspensions 26 along the vertical axis.

As an example of a fly-height positioning method, three suspensions 26 are received within the mounting structure 22. Initially, the first suspension 26 is positioned at the processing position. When the lifting assembly 62 positions the head slider 30 of the first suspension 26 at the fly-height based on the static height measured by the measuring device (not shown), the head sliders 30 of the second and third suspensions 26 are consequently positioned at a static height proximate to the required fly-height. After the static attitude of the first suspension 26 is adjusted by the static attitude adjustment apparatus 74, the indexing actuator 26 positions the mounting apparatus 28 along the indexing axis for removing the first suspension 26 from and consequently positioning the second suspension 26 at the processing position. The head slider 30 of the second suspension 26 is already positioned at the fly-height when the second suspension 26 is positioned at the processing position. This reduces the need for further reiterative positioning of the head slider 30 of the second suspension 26 using the algorithm-based control strategy.

Alternatively, the static attitude of the head slider 30 of the second suspension is measured by the measuring device (not shown) when the second suspension 26 is positioned at the processing position. However, the previous positioning of the head slider 30 of the first suspension 26 greatly reduces the height difference between the static height of the head slider 30 of the second suspension 26 and the fly-height. This greatly reduces the time required for positioning the head slider 30 of the second suspension at the fly-height by reducing the number of iterations required for generating the control strategy.

When the third suspension 26 is subsequently positioned at the processing position, the time 25 required for positioning the head slider 30 of the third suspension 26 at the fly-height is further reduced. Furthermore, the cartridge 50 used in the mounting structure 22 eliminates the need to remove and replace a suspension 26 from the mounting structure after each static attitude adjustment process for each suspension 26. The ability to pre-load and pre-align a plurality of suspensions 26 onto the cartridge 50 further eliminates redundant in-situ processes along a production line. Therefore, the fly-height positioning apparatus 20 clearly improves the efficiency of not only the fly-height positioning process for a plurality of suspensions 26, but also the static attitude adjustment process for the plurality of suspensions 26.

The fly-height positioning apparatus 20 described in this section utilizes an embodiment of the invention to illustrate how the disadvantages of conventional fly-height positioning apparatus and methods are addressed. Although only one embodiment of the invention is disclosed, numerous modifications can be made to the embodiment without departing from the scope and spirit of the invention.

What is claimed is:

1. A fly-height positioning apparatus comprising:
a base structure;
a mounting structure being movably coupled to the base structure for displacing along an indexing axis, the mounting structure for receiving a plurality of suspensions, each suspension being elongated and planar; and
an indexing actuator cooperating with the base structure and the mounting structure for positioning the mounting structure along the indexing axis relative to the base structure and thereby positioning one of the plurality of suspensions at a processing position.

2. The fly-height positioning apparatus as in claim 1, wherein each suspension has a mounting region and a head slider constituting two distal ends thereof.

3. The fly-height positioning apparatus as in claim 2, further comprising:
an alignment assembly for cooperating with the mounting structure to immobilize the plurality of suspensions mounted therein.

4. The fly-height positioning apparatus as in claim 2, further comprising:
a lifting assembly for bending a flexure portion of each of the plurality of suspensions along a pitch axis and thereby positioning the head slider of at least one of the plurality of suspensions along the pitch axis, the pitch axis being generally perpendicular to the plane of the suspension.

5. The fly-height positioning apparatus as in claim 2, the mounting structure comprising:
a first jaw and a second jaw arranged for displacing in opposing directions along a vertical axis between an open and a close position and having a pair of clamping faces being inwardly facing, the vertical axis being generally perpendicular to the indexing axis and the plane of the mounting region of the suspension.

6. The fly-height positioning apparatus as in claim 5, the mounting structure further comprising:
a plurality of datum pins received, in the first jaw, each datum pins being elongated and having a free end for engaging with the mounting region of the suspension;
a protrusion formed at the free end of each of the plurality of datum pins; and
a plurality of cavities spaced apart on the clamping face of the second jaw, wherein each cavity being dimensioned and aligned for inlaying the protrusion of the corresponding datum pin therewithin when the first and second jaws are in the close position.

7. The fly-height positioning apparatus as in claim 6, each suspension having a mounting aperture for the passage of the protrusion therethrough.

8. The fly-height positioning apparatus as in claim 7, wherein each datum pin is movably coupled to the first jaw and extending from and being perpendicular to the clamping face of the first jaw, and the datum pin being resiliently biased along the vertical axis for applying a force to and thereby gripping suspensions of various thickness.

9. The fly-height positioning apparatus as in claim 7, further comprising:
a cartridge having a plurality of recess spaced apart along its length, each recess being shaped and dimensioned for receiving the mounting region of the suspension, and having a first conduit having a central axis being coincident with the center of the mounting aperture of the suspension for the passage of the corresponding datum pin therethrough.

10. The fly-height positioning apparatus as in claim 9, wherein when the cartridge is mounted onto the first jaw by inserting each datum pin into the corresponding first conduit which consequently engages the protrusion of each datum pin through the mounting aperture of the respective suspension, the first and second jaws are subsequently positioned in the close position for inlaying each protrusion within the corresponding cavity and thereby gripping the plurality of suspensions between the clamping face of the second jaw and the plurality of respective recesses.

11. The fly-height positioning apparatus as in claim 10, further comprising:
an alignment assembly having a plurality of pins, each pin for inserting into an alignment aperture of the suspension, the alignment aperture being formed along the longitudinal axis of the suspension between the head slider and the mounting aperture, the alignment assembly being movably coupled to mounting structure along the vertical axis for inserting each pin through the respective alignment apertures and thereby immobilizing movement of each suspension about a central axis of the mounting aperture.

12. The fly-height positioning apparatus as in claim 11, further comprising:
a lifting assembly, the lifting assembly having a plurality of stubs, each stub for abutting onto a flexure portion of the corresponding suspension and thereby bending the plurality of suspensions along a pitch axis to position the head slider of the suspension positioned at the processing position at a static height relative to the mounting region of the suspension, the pitch axis being generally perpendicular to the central axis of the mounting aperture.

13. The fly-height positioning apparatus as in claim 12, further comprising:
at least one of a plurality of cams for communicating with and thereby simultaneously positioning the first and second jaws between the open and the close positions, the alignment assembly along the vertical axis, and the lifting assembly along the vertical axis, the plurality of cams having a rotational displacement; and
a positioning actuator for rotationally displacing the plurality of cams, the plurality of cams being mounted onto the positioning actuator, and the positioning actuator being electrically connected to a controller.

14. The fly-height positioning apparatus as in claim 13, further comprising:
a measuring device for measuring the static height of the head slider of the suspension positioned at the processing position, the measuring device being electrically connected to the controller and for transmitting the measured static height to the controller; and
a static attitude adjustment apparatus for interacting with the suspension to adjust a static attitude of the head slider of the suspension positioned at the processing position, the static attitude adjustment apparatus being electrically connected to the controller.

15. The fly-height positioning apparatus as in claim 14, wherein the controller determines a height difference between the static height received from the measuring device and a fly-height pre-determined by a user, the controller generating a control strategy based on the height difference for controlling the positioning actuator and consequently the rotational displacement of the plurality of cams, and thereby positioning the head slider at the fly-height.

16. A fly-height positioning method comprising the steps of:
receiving a plurality of suspensions in a mounting structure, the mounting structure being movably coupled to a base structure for displacing along an indexing axis, each suspension being elongated and planar and having a mounting aperture, and the mounting structure interacting with each mounting aperture of the plurality of suspensions for gripping the suspension;
providing an indexing actuator for cooperating with the base structure and the mounting structure to position the mounting structure along the indexing axis relative to the base structure; and
positioning one of the plurality of suspensions at a processing position along the indexing axis by the indexing actuator communicating the base structure and the mounting structure, the suspension having a mounting region and a head slider constituting two distal ends thereof.

17. The fly-height positioning method as in claim 16, further comprising the step of:
immobilizing movement of each suspension about a central axis of the mounting aperture by an alignment assembly interacting with an alignment aperture of each suspension, the alignment aperture being formed along a longitudinal axis of the suspension between the head slider and the mounting region, and the alignment assembly for displacing along a vertical axis, the vertical axis being generally perpendicular to the indexing axis and generally parallel to the central axis of each mounting aperture of the plurality of suspensions received within the mounting structure.

18. The fly-height positioning method as in claim 17, further comprising the step of:
providing a lifting assembly, the lifting assembly having a plurality of stubs, each stub for abutting onto a flexure portion of the corresponding suspension and thereby bending the plurality of suspensions along a pitch axis to position the head slider of the suspension positioned at the processing position at a static height relative to the mounting region of the suspension, the pitch axis being generally perpendicular to the central axis of the mounting aperture.

19. The fly-height positioning method as in claim 18, further comprising the steps of:
providing at least one of a plurality of cams for communicating with and thereby simultaneously positioning the first and second jaws between the open and the close positions, the alignment assembly along the vertical axis, and the lifting assembly along the vertical axis, the plurality of cams having a rotational displacement; and
a positioning actuator for rotationally displacing the plurality of cams, the plurality of cams being mounted onto the positioning actuator, and the positioning actuator being electrically connected a the controller.

20. The fly-height positioning method as in claim 19, further comprising the steps of:
measuring the static height of the head slider of the suspension positioned at the processing position by a measuring device, the measuring device being electrically connected to the controller and for transmitting the measured static height to the controller;
determining a height difference between the static height received from the measuring device and a fly-height pre-determined by a user, the height difference being determined by the controller, the controller generating a control strategy based on the height difference for controlling the positioning actuator and consequently the rotational displacement of the plurality of cams, and thereby positioning the head slider at the fly-height;
adjusting a static attitude of the head slider of the suspension being positioned at the processing position by a static attitude adjustment apparatus being electrically connected to the controller; and
removing the suspension positioned at the processing position by the indexing actuator interacting with the mounting structure.
